(19) United States
(12) Patent Application Publication
(10) Pub. No.: US 2005/0259289 A1
(43) Pub. Date: Nov. 24, 2005

(54) Print driver job fingerprinting

(75) Inventors: Andrew Rodney Ferlitsch, Tigard, OR (US); Roy Kenneth Chrisop, Camas, WA (US); Daniel Leo Klave, Camas, WA (US)

Correspondence Address: Gerald W. Maliszewski, P.O. Box 270829, San Diego, CA, 92198-2829, US

(73) Assignee: Sharp Laboratories of America, Inc.

(21) Appl. No.: 10/842,390

(22) Filed: May 10, 2004

(51) Int. Cl. G06F 3/12; G06F 15/163; G06K 15/02; G08B 29/00; H04L 9/00; H04L 9/32

(52) U.S. Cl. 358/1.14; 358/3.28; 358/1.15; 340/5.82; 340/5.8; 358/1.18; 358/1.13; 713/176; 713/182

(57) ABSTRACT

A system and method are provided for print job fingerprinting in a print job generation system. The method comprises: at a print job generation system, accepting an electronically formatted document with print instructions; accepting fingerprint information; generating a fingerprint image from the fingerprint information; supplying a fingerprinted print job; and, generating a raster image of the fingerprinted print job. For example, the fingerprinted print job may be sent, via a print subsystem, to a printer that creates a raster image of the fingerprinted print job and generates a copy of the document, with the fingerprint image. The fingerprinted print job is generated in a format such as a journaled print job, page description language (PDL), machine-dependent raster image data, or machine independent bitmap data. The image can be a marking such as a barcode, alpha-numeric text, watermark, font set, or steganographic image.

### BACKGROUND OF THE INVENTION

1. Field of the Invention

This invention generally relates to digital image processing and, more particularly, to a print job generation system and method for fingerprinting a print job.

2. Description of the Related Art

The origin and certain other details associated with the rendered output of a print job, are not conventionally embedded in the print job. Further, even the job characteristics that accompany a print job cannot be extracted, once the print job is printed. Thus, information concerning the origin of the print job, such as the desired anti-copy protection criteria, or the printer identification that produced the output, is lost. If this information is not printed with the document, administrators cannot detect or trace back the misuse of the printing devices, where confidentiality is an issue, or provide forensics information as to the source of a printout, when the document is associated with a crime investigation. The process of providing information about a document, with the document, when the document is rendered into an output, is referred to herein as fingerprinting.

FIG. 1A is a diagram illustrating a barcode fingerprint (prior art). One conventional fingerprinting means is barcoding. In this case, a barcode containing the fingerprint information is added to a part of the printed document in such a way as to not obscure the print image. For example, the barcode may be added to a binding edge, in a portion of the document that is not used for stapling or hole punching. Alternately, the barcode may be added to an unused area of a page footer. The barcode can subsequently be scanned to read the fingerprint information. Barcodes may contain a substantial amount of redundant information, so that they remain reliable, even after copying or rescanning.

FIG. 1B is a diagram depicting a serialized fingerprint (prior art). Another method of fingerprinting is serialization. In this case, a human readable text string containing the fingerprint information is added to a part of the printed output that does not contain the print image; as described for the barcode above. Generally, the text string contains an identifier for each printout that is used to uniquely identify each instance, for example, the serial number of a copy. The serial number can subsequently be read by a human, or scanned/OCR (optical character recognition), to recover the fingerprint information. The serial number fingerprints can be accurately copied with a high reliability.

FIG. 1C is a diagram depicting a watermark fingerprint process (prior art). Another method of fingerprinting is the use of a digital mark added to the printed output. For example, a digital mark may be added as a watermark. This method suffers in that it modifies the print image. If the digital mark is added “beneath” the print image (underlay), portions of the digital mark may be obscured by the print image, resulting in a loss of fingerprint information. If the digital mark is added above the print image (overlay), portions of the print image may be obscured by the digital mark, resulting in a lost of some of the print image. If overlapping parts of the print image and digital mark are merged together (composite), then a trade-off can be performed between the loss of fingerprint information vs. loss of print image. The digital mark can subsequently be recognized by either a human or scan process. Copying of the printed output may result in a deterioration of the fingerprint information.

It would be advantageous if fingerprint information could be added to a print job seamlessly by a print driver, or a print job generation system, before the print job is raster image processed.

It would be advantageous if a fingerprint, once it has been added to a print job, could remains intact with any subsequent rendering of the print job.

It would be advantageous if the system adding the fingerprint could be embedded in a client computer device, printer, or a print server.

### SUMMARY OF THE INVENTION

The present invention improves on fingerprinting a print job with respect to the prior and illustrative art in that it can be implemented by the print driver, or other print job generation means. The invention is independent of the method used to rasterize the image. That is, the inventions works with page description language (PDL) printers and journal printing instructions, such as EMF in Microsoft Windows. Further, the invention is independent of the method used to transmit the print job to the destination device(s). That is, it works with existing print providers, that may be locally, network, or remotely connected.

The invention can collect information on the presumed (intended) destination of the print job. The fingerprinting method may be implemented at the source origination, such as client computing device, whereby source origination information can be collected. The fingerprinting method may also be implemented at the print server, whereby routing information can be collected. The fingerprinting information is collected pre-raster image processing (pre-RIP), whereby the fingerprint can be added by analyzing the content information, as well as imaging and job information.

Accordingly, a method is provided for print job fingerprinting in a print job generation system. The method comprises: at a print job generation system, accepting an electronically formatted document with print instructions; accepting fingerprint information; generating a fingerprint image from the fingerprint information; supplying a fingerprinted print job; and, generating a raster image of the fingerprinted print job. For example, the fingerprinted print job may be sent, via a print subsystem, to a printer that creates a raster image of the fingerprinted print job and generates a copy of the document, with the fingerprint image.

Accepting fingerprint information may include accepting information such as job ownership/origination, host, target printer, routing, job assembly, job scheduling, metadata, or job content information. The fingerprinted print job is generated in a format such as a journaled print job, page description language (PDL), machine-dependent raster image data, or machine independent bitmap data. Typically, the fingerprint image is generated in the same format as the print job. The image can be a marking such as a barcode, alpha-numeric text, watermark, font set, or steganographic image.

Additional details of the above-described method and a print job generation fingerprinting system are provided below.

### BRIEF DESCRIPTION OF THE DRAWINGS

FIG. 1A is a diagram illustrating a barcode fingerprint (prior art).

FIG. 1B is a diagram depicting a serialized fingerprint (prior art).

FIG. 1C is a diagram depicting a watermark fingerprint process (prior art).

FIG. 2A depicts the introduction of fingerprint information at the print source.

FIG. 2B depicts the introduction of fingerprint information by a dedicated print server security module.

FIG. 2C is a drawing depicting the introduction of a fingerprint by a printer.

FIG. 2D illustrates a method of watermarking that may be used to hide a digital signature in the printed image.

FIG. 3 is a schematic block diagram of the present invention print job generation fingerprinting system.

FIG. 4A is a drawing depicting the fingerprinting print process embedded in a client computing device.

FIG. 4B is a drawing depicting the fingerprinting print processor embedded in a print server computing device.

FIG. 5 is a drawing depicting the fingerprinting invention implemented with a journaled print job by a print server.

FIG. 6A is a figure depicting print job configuration by the user.

FIG. 6B is a depiction of installation by an administrator.

FIG. 6C is a depiction of an installation by an external interface.

FIG. 6D is a depiction of an installation made at run-time through a user interface.

FIG. 7 is a flowchart illustrating the present invention method for print job fingerprinting in a print job generation system.

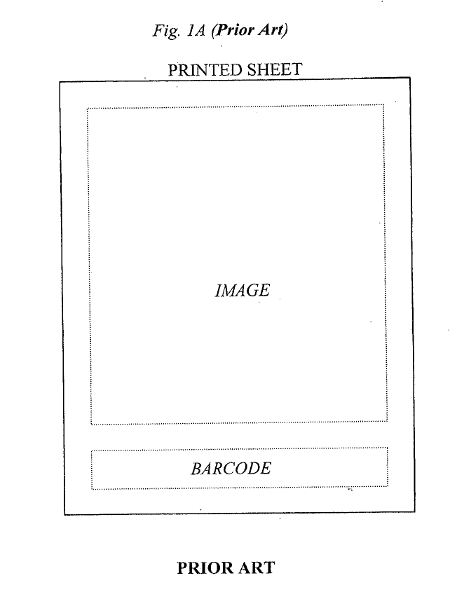

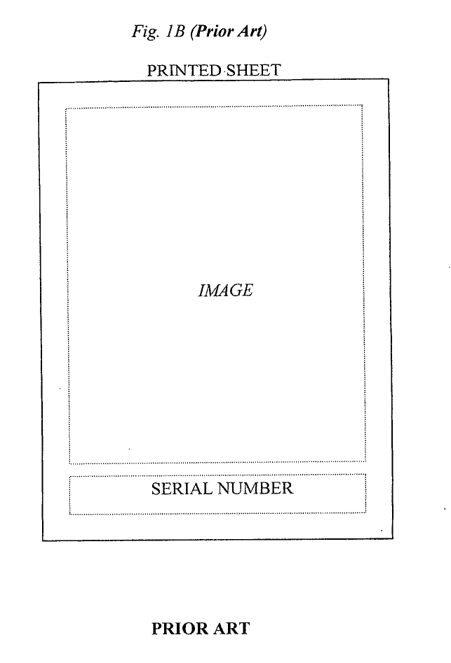

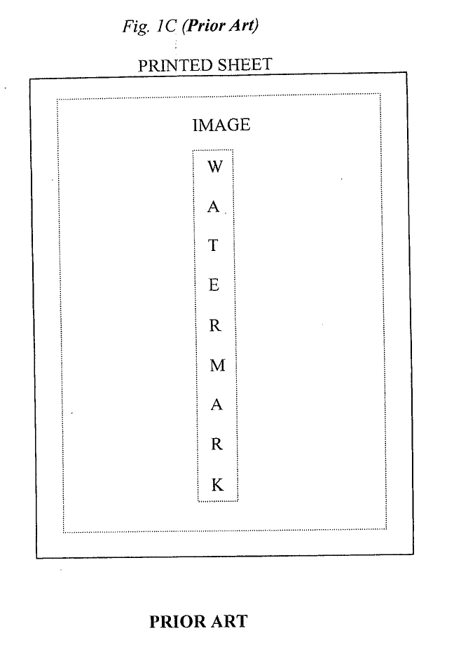

### DETAILED DESCRIPTION OF THE PREFERRED EMBODIMENTS

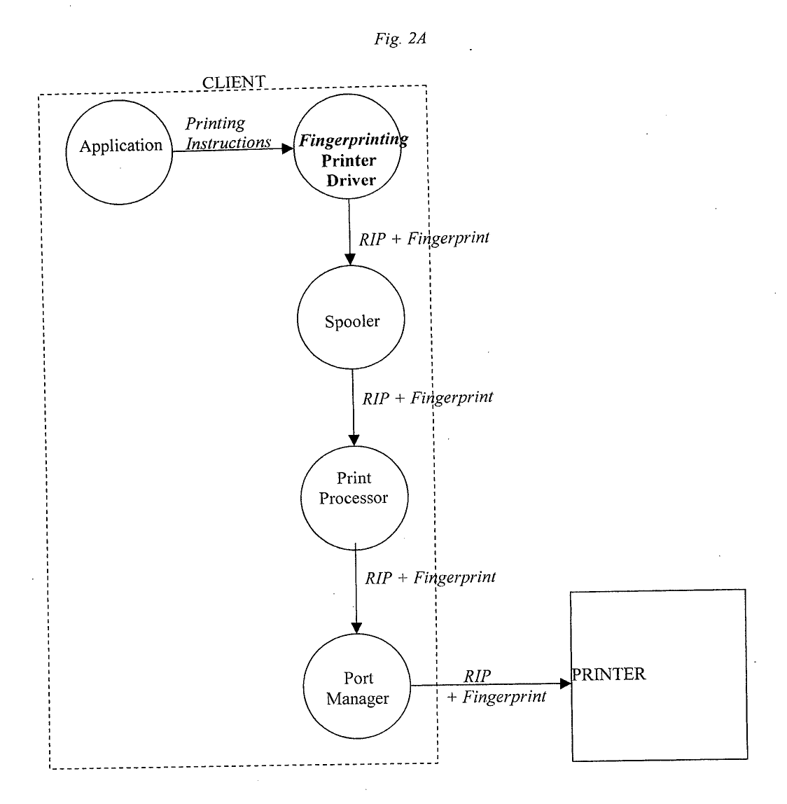

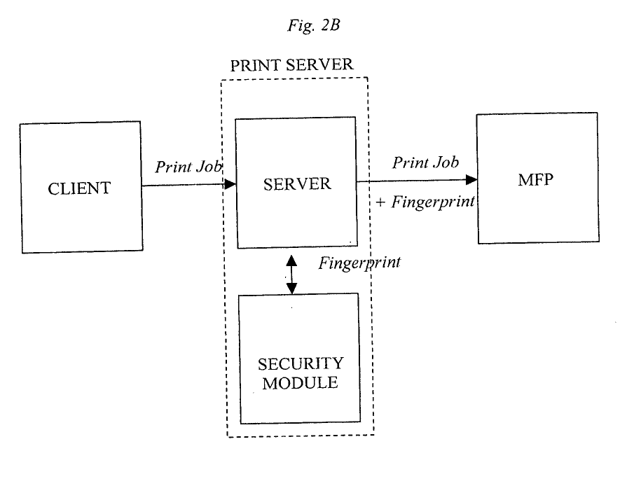

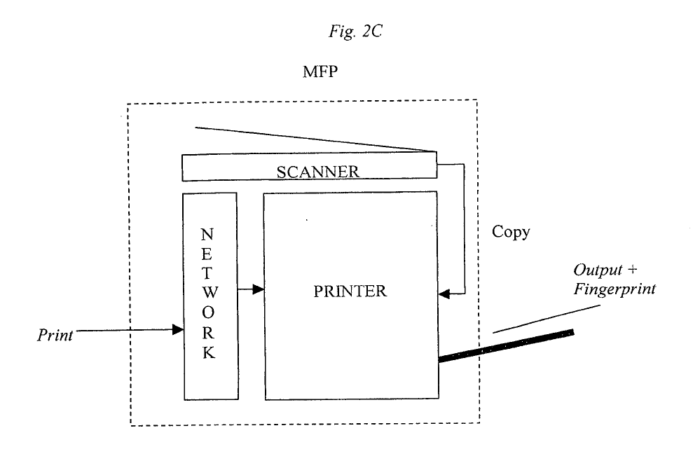

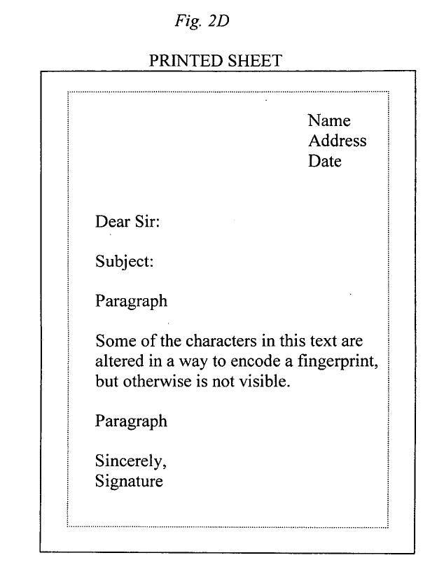

FIG. 2A depicts the introduction of fingerprint information at the print source. The print subsystem, at the source initiating the print job, adds the fingerprint to the print data. For example, the fingerprint may be added by a printer driver, as described in pending application WO0174053. However, the method does not work with PDL print jobs, as the printer driver cannot anticipate the final image that will be produced by the printing device's own half-toning and error diffusion algorithms.

Neither does this solution work if the print job is journaled on a client, spooled to a network print server, and rendered on a print server. An example of this includes EMF spooling from a Windows NT client to Windows NT print server. In this case, the client information is lost since the print job is rendered by the printer driver on the server, and not the client. In another incomplete method of addressing the fingerprinting issue (not shown), a fingerprinting print processor can be used, instead of a fingerprinting print driver, to add a fingerprint. However, many of the above-mentioned problems still exist.

FIG. 2B depicts the introduction of fingerprint information by a dedicated print server security module. The print subsystem, on a print server that manages print jobs to the printing device, performs security functions related to the print job, such as authenticating a user or enforcing printing restrictions. See publication US20020042884, entitled, REMOTE PRINTING OF SECURE AND/OR AUTHENTICATED DOCUMENTS.

FIG. 2C is a drawing depicting the introduction of a fingerprint by a printer. The printer firmware adds the fingerprint to the print data. For example, the fingerprint may be added by a rasterization process.

FIG. 2D illustrates a method of watermarking that may be used to hide a digital signature in the printed image (prior art). In pending patent application Ser. No. 10/617,483, entitled SECURITY FONT SYSTEM AND METHOD FOR GENERATING TRACEABLE PAGES IN AN ELECTRONIC DOCUMENT, invented by Mary Bourret, fingerprint information is embedded by altering the characteristics of a font set.

FIG. 3 is a schematic block diagram of the present invention print job generation fingerprinting system. The system 300 comprises a print job generation system 302 (PJGS) having an interface on line 304 to accept an electronically formatted document with print instructions. The source of the document may be an application, for example MS Word, Excel, Power Point, or Word Perfect. However, the invention is not limited to any particular kind of application. The print instructions may be print job generation system dependent, or a print job generation system independent instructions.

The print job generation system 302 is embedded in the host 305. Generally, the host 305 may be a client computing device, a printer, or a print server. The print job generation system 302 supplies the print job and fingerprint image in a format such as a journaled print job, page description language (PDL), such a printer control language (PCL), PostScript (PS), or PDF, machine-dependent raster image data, or machine independent/bitmap data, such as TIFF.

The print job generation system 302 has an interface on line 306 to accept fingerprint information. The print job generation system 302 generates a fingerprint image from the fingerprint information and supplies a fingerprinted print job at an output on line 308. Typically, the print job generation system 302 is a print driver. However, in other aspects of the system it is a host print transform (HPT), such as on the IBM AS/400 operating system, or a direct print/image submit application.

The system typically comprises a raster image processor (RIP) 310 having an input on line 312 to accept the fingerprinted print job and an output on line 314 to supply a raster image of the fingerprinted print job. More specifically, the system may further comprise a print subsystem 316 having an input on line 308 to accept the fingerprinted print job and an output on line 312 to distribute the fingerprinted print job. A conventional print subsystem may include components such as a spooler 313 for print job storage, a print processor (not shown), port manager (not shown), or a print assist (not shown).

Also shown is a printer 318. The RIP 310 is embedded in printer 318. A print engine 320 has an input on line 314 to accept the raster image and an output on line 322 to supply a rendering of the document, with the fingerprint image. For example, the printer 318 supplies a hardcopy or otherwise tangible copy of the document with the added fingerprint image. Shown is a printed document where the fingerprint image is represented by the circled letter, capital “A”.

More generally, the system may be thought of as further comprising a rendering system 324 that may be a printer, scanner, fax, http server, document server, email server, or print job converter system. This rendering system has an input on line 312 to accept the fingerprinted print job and an output on line 326 to supply a rendered print job with the fingerprint image. The rendering may either be a soft (electronically formatted) copy, or a hard (tangible format) copy of the fingerprinted print job.

The print job generation system 302 accepts fingerprint information on line 306 such as job ownership/origination, host, target printer, routing, job assembly, job scheduling, metadata, and/or job content information. Job ownership/origination fingerprint information includes user name, biometric data, and a digital signature associated with the source of the electronically formatted document. Job scheduling fingerprint information includes job name, job ID, job submission time and date, and job size. Job assembly fingerprint information includes the number of pages/sheets, sheet assembly (duplex, n-up, booklet, tri-fold), finishing (stapling, folding, hole-punching, cutting, trimming), collation (copies, face-up, color separation), rendering (color, dpi, resolution), and consumables (paper stock and ink).

Routing fingerprint information includes print server name, print server queue, print server network address, port name, and print provider. Host fingerprint information includes host name, host machine address (MAC), and host network address, such as an IP address. Target printer fingerprint information includes printer name, printer model name, printer serial number, printer network address. Metadata fingerprint information includes access control and anti-copy protection information. That is, information concerning who has access to see, print, or distribute the print job.

In another aspect, the print job generation system 302 analyzes content information from the electronically formatted document, and generates a fingerprint image in response to the content information analysis.

Generally, the print job generation system 302 adds the fingerprint image to the print job either prior to rendering the print job, or while rendering the print job. In some aspects of the system, the print job generation system 302 generates and spools journaled data to the print subsystem 312. Subsequently, the print job generation system 302 despools the journaled data and adds the fingerprint image.

The print job generation system 302 may a fingerprinted print job with the fingerprint image in a format such as a barcode, alpha-numeric text, watermark, font set, and steganographic image. The invention is not limited to any particular image type. In some aspects, the print job generation system 302 supplies a fingerprinted print job having the fingerprint image scaled with respect to the sheet picture frame.

In a different aspect, the print job generation system 302 encrypts the fingerprint information and generates a fingerprint image from the encrypted fingerprint information. Alternately, (pre) encrypted fingerprint information may be accepted on line 306 and a fingerprint image may be generated from the encrypted fingerprint information. The image may plainly display the information in its encrypted form, or the image itself may be stenographic.

The rendering system 324 (i.e., printer, scanner, fax, http server, document server, email server, or print job converter system) may accept the fingerprinted print job with the encrypted information image and supply a rendered print job with the decrypted fingerprint image on line 326. For example, a printer may decrypt the information and superimpose the information in decrypted form as a watermark overlying a printed document.

In a different aspect, the print job generation system 302 adds a fingerprint image as print instructions accompanying a pre-RIP print job. Then, the printer-embedded RIP 310 accepts the fingerprinted print job, renders the fingerprint image print instructions and pre-RIP print job, and supplies a raster image of the fingerprinted print job at an output on line 314. The print engine 320 has an input on line 314 to accept the raster image and an output on line 322 to supply a rendering of the document, with the fingerprint image.

### Functional Description

Fingerprint by Printer Driver

In one aspect of the invention, the print job is generated by a printer driver. Generally, the output from the printer driver, for example a spool file, is spooled to a spooler. The spooler despools the print job to a print processor associated with the selected printing device(s). The print processor then despools the print job to a port manager associated with the printing device, if the print job is rendered, or plays back the print job to the printer driver associated with the installed printer, if the print job is journaled. In other print subsystems, such as the spooling option ‘print directly to printer’ in Microsoft Windows, the spooler directly despools the rendered print job to the printing device.

During the rendering or journaling process, the printer driver collects information on the print job origin, print destination device and intermediate destination devices, such as a print server, and records some or all of the information as a fingerprint, by any means, into a pre-RIP or journaled print job. The information may be collected prior to rendering the print job, while rendering the print job, or after the print job is rendered. The fingerprint may also be further secured by encryption and access control mechanisms.

Print job information may be collected through a variety of means, but not limited to:
1. Parsing the print job.
2. Obtaining information from the job scheduler.
3. Obtaining information from the host device.
4. Obtaining information from the destination device.
5. Obtaining information from an intermediate device.
6. Monitoring the Print Job

The information collected may fall into the following categories:
1. Job Owner Information
   a. User Name
   b. Biometric Data
   c. Digital Signature
2. Job Scheduling Information
   a. Job Name
   b. Job ID
   c. Job Submission Date & Time
   d. Job Size
3. Job Assembly Information
   a. Number of Pages/Sheets
   b. Sheet assembly (e.g., duplex, n-up, booklet, tri-fold)
   c. Finishing (e.g., stapling, folding, punching, trimming, cutting)
   d. Collation (e.g., copies, face-up, color separation)
   e. Rendering (e.g., color, dpi, resolution)
   f. Consumables (e.g., paper stock, ink)
4. Job Routing Information
   a. Printer Server Name
   b. Printer Server Queue
   c. Printer Server Network Address
   d. Port Name
   e. Print Provider
5. Host Information
   a. Host Name
   b. Host Network Address
   c. Host Machine Address
6. Printer Information
   a. Printer Name
   b. Printer Model Number
   c. Printer Serial Number
   d. Printer Network Address
7. Metadata
   a. Access Control
   b. Anti-Copy Protection

In this aspect, the fingerprinting print driver can be on the client computing device and/or server computing device, in the case of a journaled print job, such as EMF, spooled to a network printer.

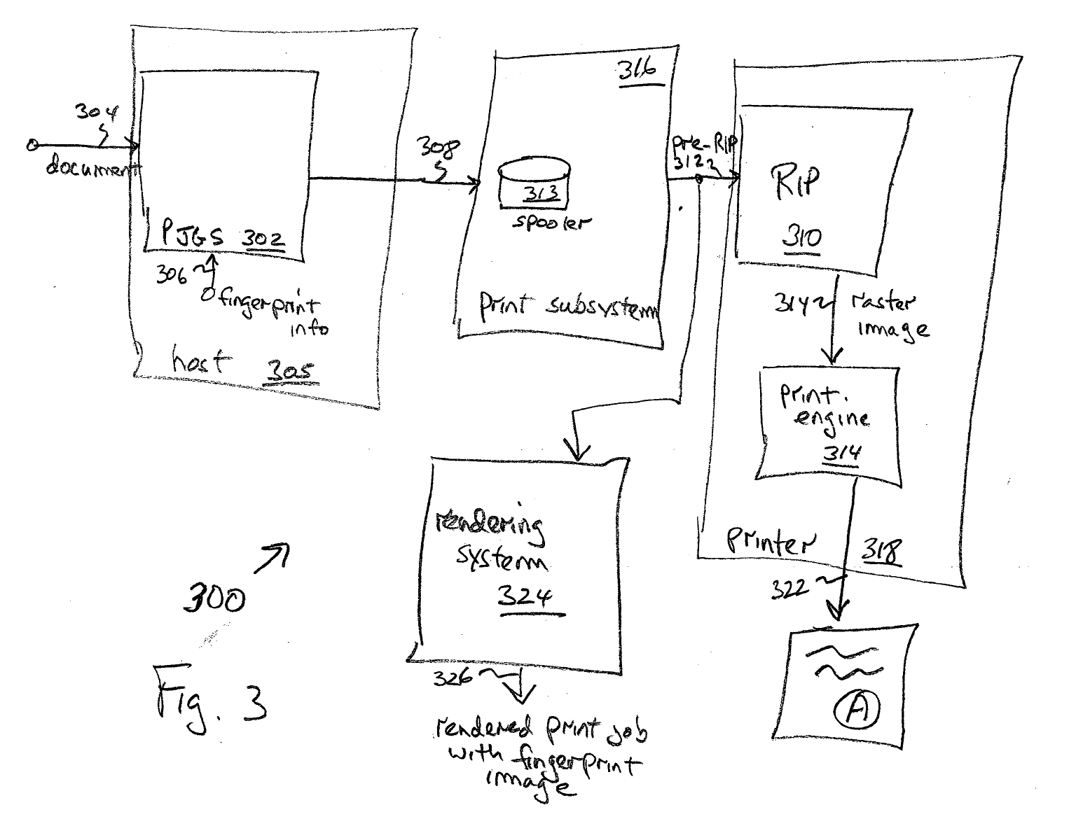

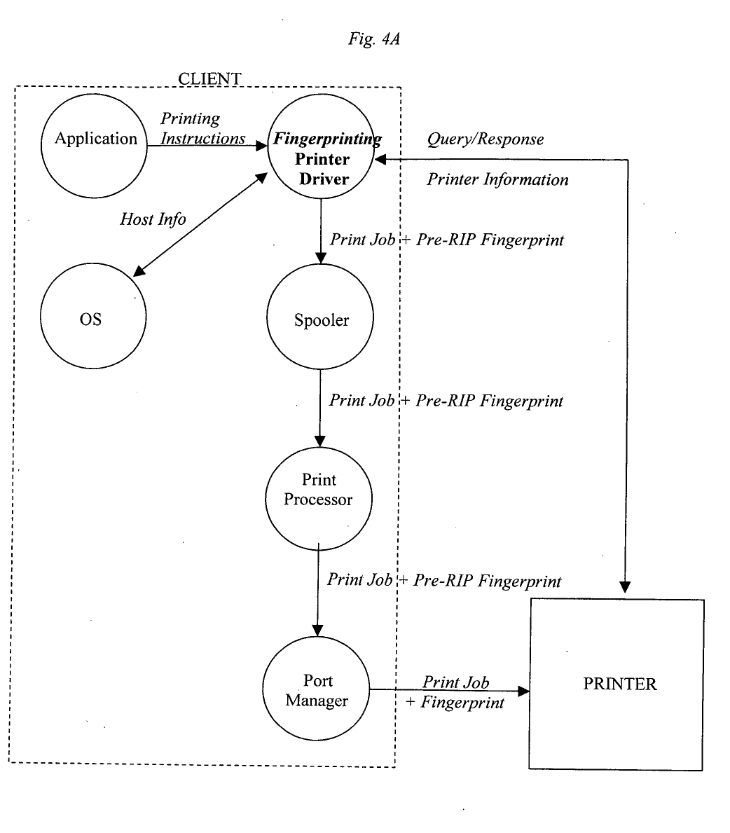

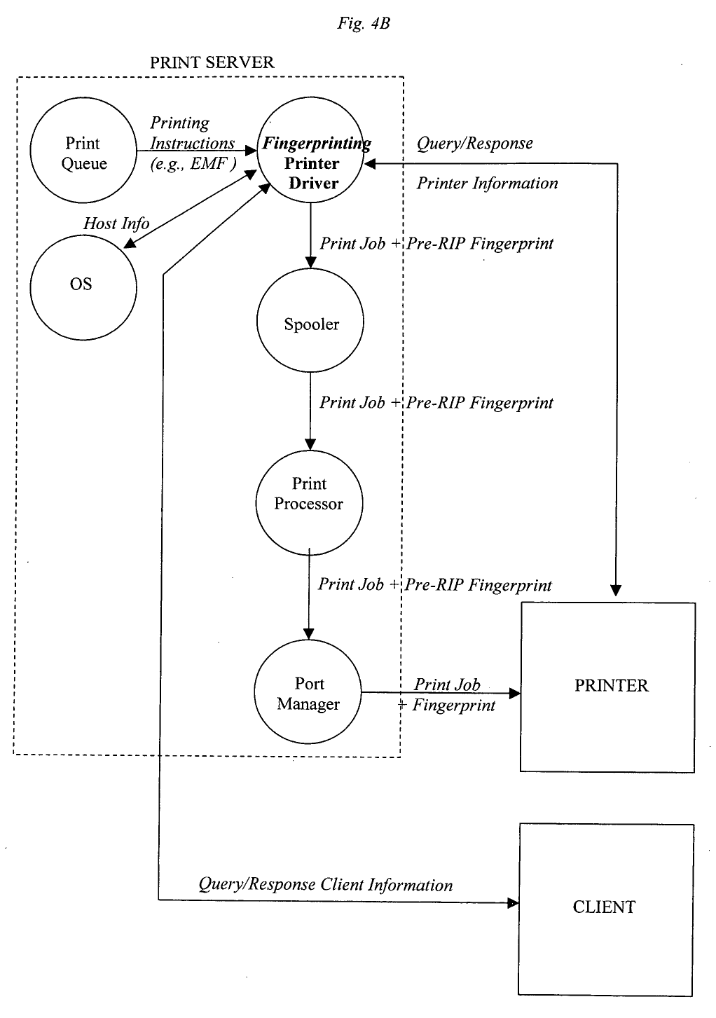

FIG. 4A is a drawing depicting the fingerprinting print process embedded in a client computing device. In this example, the fingerprinting print processor obtains information from:
The client operating system—collecting information about the client device, such as client name, host machine address, or network address.
The spooler—collecting information about the job, such as print queue, document name, document format type, user id, submit date & time, or job size.
The printer firmware—collecting information about the printing device, such as serial number, printer name, printer model, or network address.
The print server, if any, collecting information about the server device, such as such as server print queue, server name, host machine address, or network address.

FIG. 4B is a drawing depicting the fingerprinting print processor embedded in a print server computing device. In this example, the fingerprinting print processor obtains information from:
The server operating system—collecting information about the server device, such as server name, server print queue, server machine address, or network address.
The spooler—collecting information about the job, such as print queue, job name, user id, submission date & time, or job size.
The printer firmware—collecting information about the printing device, such as serial number, printer name, printer model, or network address.
The client—collecting information about the client device, such as serial number, printer name, printer model, or network address.
   Fingerprinting—Pre-RIP

In this aspect of the invention, the fingerprint printing instructions are added in a pre-RIP stage. In general, the output format of the printer driver is a PDL, such as PCL, Postscript, or PDF. The fingerprinting instructions appear in the same format as the printer driver output.

By generating the fingerprint instructions prior to the RIP and in the output format of the printer driver, the following advantages are obtained:
a. No change to the printer PDL interpreter is required. That is, the fingerprint instructions are already in the native print language of the printing device.
b. The fingerprint can use the context of the printing instructions, for example textual information.
c. The placement/scale of the image on paper can be altered to accommodate the fingerprint.

For example, if the fingerprint method is a barcode, the printer driver may consider the following factors and actions:
i. Determine the printable area of the sheet. This is generally obtained from the printer driver, but may otherwise be obtained by querying the printing device.
ii. Determine the picture frame on the sheet. This is the area within the printable area that the printer driver will render the page data into. This determination is generally made in the printer driver, usually considering such factors as the page size and printing constraints determined from the printing instructions.
iii. Determine the unused spacing (height) between the bottom margin of the picture frame and the bottom margin of the printable area.
iv. If the unused space is zero, or below some predetermined minimum, for example the minimum height required for the barcode, then the picture frame can be scaled so that the unused space meets the minimum requirement.
v. Scale the barcode to fit the unused space.
vi. Generate printing instructions to render the barcode at the determined position/scale.

In another example, the fingerprint method is a font steganography. In this case, the fingerprint is encoded into some subset of font glyphs. The printer driver may consider the following factors and actions:
a. Determine the amount of textual information available. For example, the printer driver may count the number of unique instances per character per font.
b. Determine the number of characters needed to encode the fingerprint.
c. Determine the number of characters needed for calibration.

For example, the font steganography may use a technique where the encoded font glyphs deviate from the original font glyphs by some statistical amount. The calibration encodes some known pattern of information repetitiously, such that a subsequent scan by an imaging device detects the calibration and derives the statistical deviations.
d. If an insufficient numbers of characters are generated for the encoding/calibration, then either the information needed to encode is reduced, or a different encoding/fingerprinting method is selected.
e. Select a subset of character sequences for the calibration.
f. Select a subset of character sequences for the encoding.
g. Assign new font glyphs for the character sequences in the calibration.
h. Assign new font glyphs for the character sequences in the encoding.
i. Modify the printing instructions for the selected character sequences to use the new font glyphs.
j. Download the new font glyphs with the print job.
   Fingerprinting—Journaled Mode to Print Server

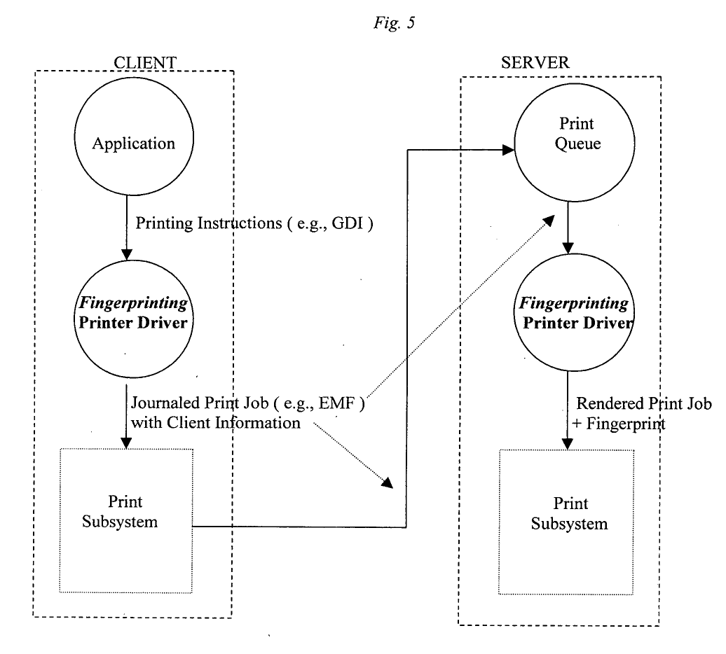

FIG. 5 is a drawing depicting the fingerprinting invention implemented with a journaled print job by a print server. In this aspect, a printer driver on a client computing device journals the printing instructions and spools the journaled print data to a print queue on a network print server. For example, EMF can be despooled to a network printer on a WinNT print server. The rendering of the printing instructions into printer ready data is deferred to the printer driver associated with the network printing on the network print server.

At this point in the process, it is likely that some, or all of the client computing information is known by the printer driver on the server computing device. In this case, the client information can be embedded into the journaled print data by the client side printer driver and extracted by the server side printer driver from the journaled print data.

For example, in the Microsoft family of operating systems, the printer driver can add the information in a proprietary section of the Print Job DEVMODE that is prepended to the printing instructions. The printer driver on the print server reads the proprietary section and extracts out the information.

Fingerprinting—PJL Instructions to the Firmware

In this alternate aspect, the printing instructions in the printer ready format are generated by the printer firmware instead of the printer driver. The printer driver, instead of generating printing instructions, generates a sequence of commands in a proprietary format that instructs the printer firmware to encode a fingerprint into the printed output. For example, the proprietary commands may be an extension to PJL or a PDL format, but not necessarily limited to these formats. Below is an example:
UEL//Standard: Universal Exit Language
EscE//Standard: Printer Reset
@PJL DUPLEX=on//Standard: Duplex Print Job
@PJL FINGERPRINTMETHOD=BARCODE//Proprietary: Use Barcode Fingerprint
@PJL FINGERPRINTINFO=“ . . . ”//Proprietary: Information to encode

The printer firmware performs functions to encode the fingerprint in a manner similar to the printer driver in the above-mentioned aspects.

Fingerprint—Configuration

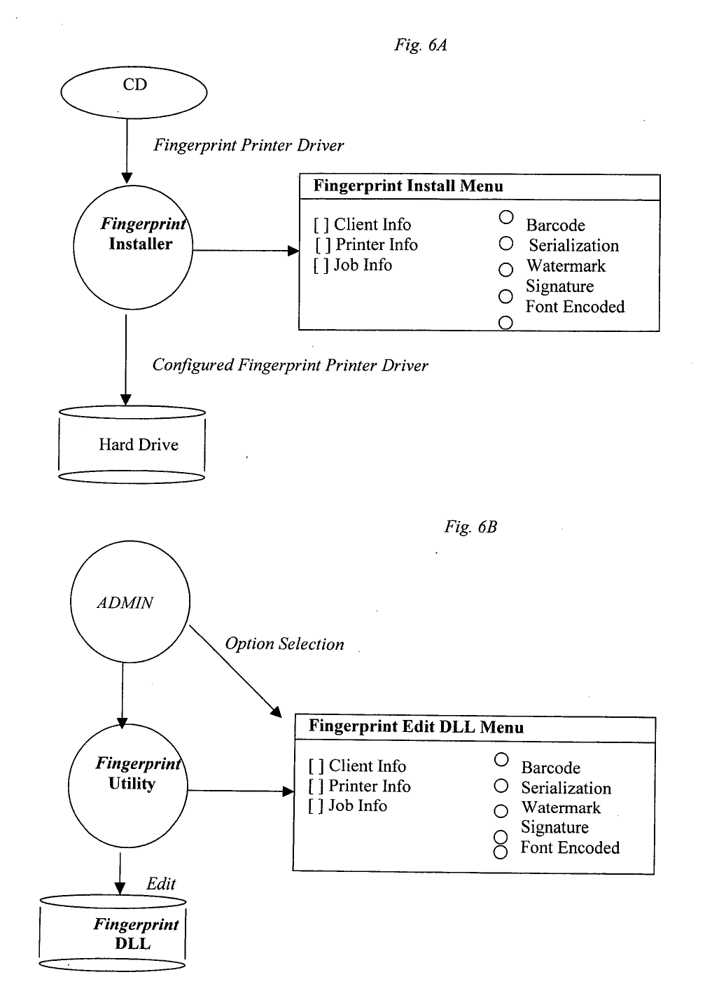

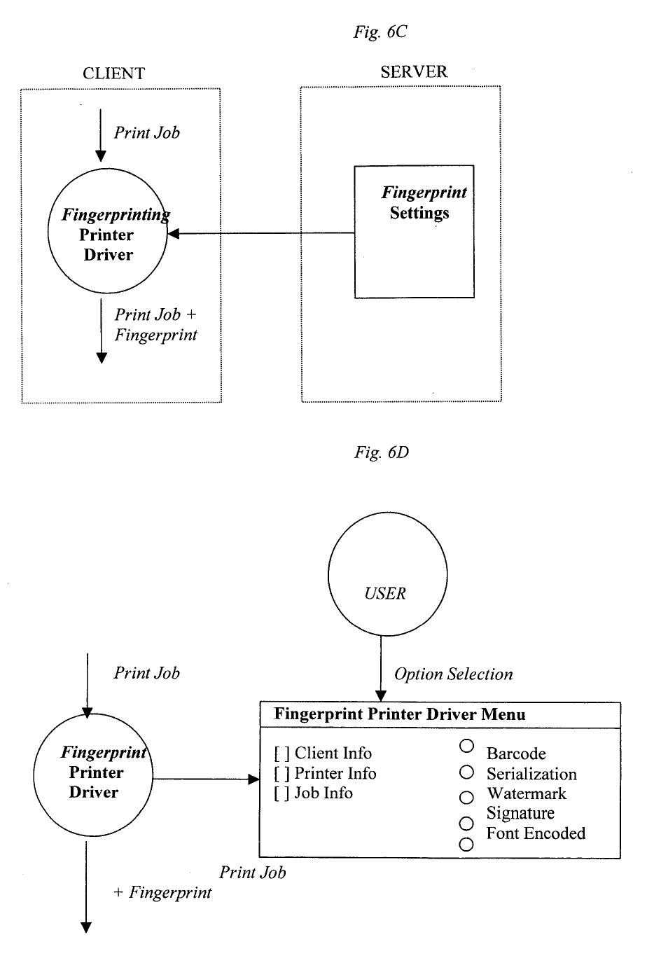

FIG. 6A is a figure depicting print job configuration by the user. The fingerprint information collected and/or method used to imprint the information into the print job may be made configurable during installation by the user. The installer may present the user/administrator with options relating to fingerprinting, including the information to be fingerprinted, such as the host name, and method of fingerprinting, such as barcode.

FIG. 6B is a depiction of installation by an administrator. The administrator may pre-configure the installation, such as using a utility to construct or edit a text or binary file that contains the configuration settings and becomes part of the process, such as an executable dynamic link library.

FIG. 6C is a depiction of an installation by an external interface. The fingerprint process may read a configuration/settings file from a predetermined place on the network.

FIG. 6D is a depiction of an installation made at run-time through a user interface. The fingerprint process may display a user interface at run-time to the user, whereby the user selects the fingerprinting options.

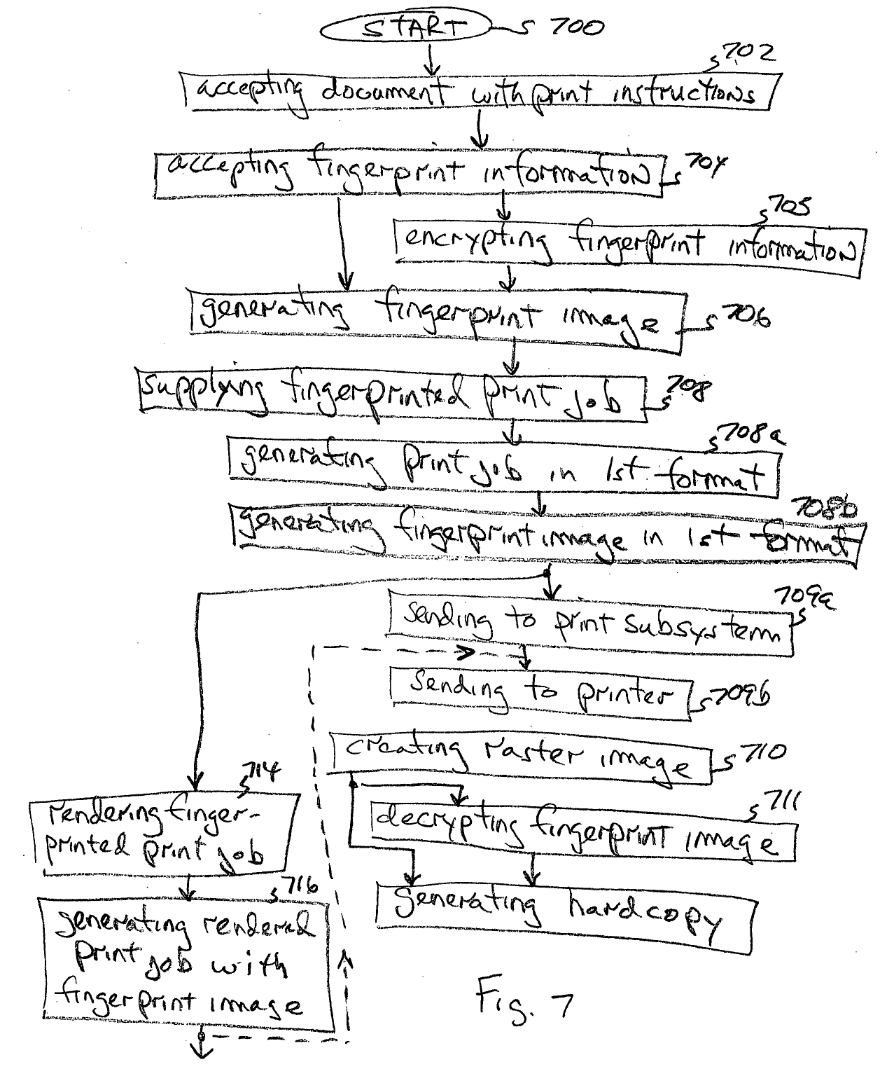

FIG. 7 is a flowchart illustrating the present invention method for print job fingerprinting in a print job generation system. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 700.

Step 702, at a print job generation system, accepts an electronically formatted document with print instructions. Step 704 accepts fingerprint information. Step 706 generates a fingerprint image from the fingerprint information. Step 708 supplies a fingerprinted print job. For example, the fingerprinted print job may scale the fingerprint image with respect to the sheet picture frame. The fingerprinted print job may add the image as a barcode, alpha-numeric text, watermark, font set, or steganographic image for example. Step 710 creates a raster image of the fingerprinted print job.

In some aspects, Step 709a sends the fingerprinted print job to a print subsystem. Step 709b sends the fingerprinted print job from the print subsystem, to a printer. Then, Step 712 generates a hardcopy of the document, with the fingerprint image. Alternately, Step 714, subsequent to supplying the fingerprinted print job, renders the fingerprinted print job using a process such as copying, scanning, faxing, printing, transferring, or converting the print job format. As used herein, transferring in a part of the imaging process involving the use of a printer or MFP as an email, http, or document server. Then, Step 716 generates a rendered print job with the fingerprint image.

In one aspect, accepting an electronically formatted document at a print job generation system in Step 702 includes accepting the document at a print job generation system embedded in a host such as a client computing device, printer, or a print server. In another aspect, Step 702 accepts the electronically formatted document at a print driver. In a different aspect, Step 702 accepts print instructions as either print job generation system dependent, or print job generation system independent instructions.

In another aspect, accepting fingerprint information in Step 704 includes accepting information such as job ownership/origination, host, target printer, routing, job assembly, job scheduling, metadata, or job content information. Job ownership/origination fingerprint information includes information such as user name, biometric data, and a digital signature associated with the electronically formatted document source. Job scheduling fingerprint information includes information such as job name, job ID, job submission time and date, and job size.

Job assembly fingerprint information includes information such as the number of pages/sheets, sheet assembly (duplex, n-up, booklet, tri-fold), finishing (stapling, folding, hole-punching, cutting, trimming), collation (copies, face-up, color separation), rendering (color, dpi, resolution), and consumables (paper stock and ink). Routing fingerprint information includes information such as print server name, print server queue, print server network address, port name, and print provider. Host fingerprint information includes information such as host name, host machine address (MAC), and host network address.

Target printer fingerprint information includes information such as printer name, printer model name, printer serial number, and printer network address. Metadata fingerprint information includes information such as access control and anti-copy protection information.

Supplying a fingerprinted print job in Step 708 may include adding the fingerprint image in one of the following processes: adding the fingerprint image to the electronically formatted document prior to rendering the print job; adding the fingerprint image while rendering the print job; or, adding the fingerprint image after rendering the print job into a pre-raster image process (RIP) format.

In another aspect, Step 708 includes substeps. Step 708a generates a print job in a first format such as a journaled print job, page description language (PDL), machine-dependent raster image data, or machine independent bitmap data. Step 708b generates the fingerprint image in the first format.

In one aspect, accepting fingerprint information in Step 704 includes analyzing content information from the electronically formatted document. Then, Step 706 generates a fingerprint image in response to the content information analysis.

In a different aspect, Step 705 encrypts the fingerprint information, and Step 706 generates a fingerprint image from the encrypted fingerprint information. Alternately, accepting fingerprint information in Step 704 includes accepting encrypted fingerprint information, and Step 706 generates a fingerprint image from the encrypted fingerprint information. In one aspect, Step 711, subsequent to supplying the fingerprinted print job, decrypts the fingerprint image. Then, Step 712 renders a print job with the decrypted fingerprint image.

In another variation of the invention, supplying a fingerprinted print job in Step 708 includes other substeps (not shown). Step 708c adds a fingerprint image as print instructions accompanying a pre-RIP print job. Step 708d, at a printer, renders the fingerprint image print instructions and pre-RIP print job into a raster image of the fingerprinted print job.

A system and method have been presented for fingerprinting a print job in a print job generation system. Examples of processing modules and specifically ordered process steps have been used to clarify the invention. However, the invention is not limited to merely the examples. Although the invention has generally been explained in the context of a Microsoft Windows® operating system, the invention can also be practiced with subsystems of an Apple MacIntosh Operating System, Linux Operating System, System V Unix Operating Systems, BSD Unix Operating Systems, OSF Unix Operating Systems, Sun Solaris Operating Systems, HP/UX Operating Systems, or IBM Mainframe MVS and AS/400 Operating System, to name a limited list of other possibilities. Other variations and embodiments of the invention will occur to those skilled in the art.

1. A method for print job fingerprinting in a print job generation system, the method comprising:
at a print job generation system, accepting an electronically formatted document with print instructions;
accepting fingerprint information;
generating a fingerprint image from the fingerprint information; and,
supplying a fingerprinted print job.

2. The method of claim 1 further comprising:
sending the fingerprinted print job to a print subsystem;
sending the fingerprinted print job from the print subsystem, to a printer;
creating a raster image of the fingerprinted print job; and,
generating a hardcopy of the document, with the fingerprint image.

3. The method of claim 1 wherein accepting an electronically formatted document at a print job generation system includes accepting the document at a print job generation system embedded in a host selected from the group including a client computing device, printer, and a print server.

4. The method of claim 1 wherein accepting fingerprint information includes accepting information selected from the group including job ownership/origination, host, target printer, routing, job assembly, job scheduling, metadata, and job content information.

5. The method of claim 4 wherein accepting job ownership/origination fingerprint information includes accepting information selected from the group including user name, biometric data, and a digital signature associated with the electronically formatted document source.

6. The method of claim 4 wherein accepting job scheduling fingerprint information includes accepting information selected from the group including job name, job ID, job submission time and date, and job size.

7. The method of claim 4 wherein accepting job assembly fingerprint information includes accepting information selected from the group including the number of pages/sheets, sheet assembly (duplex, n-up, booklet, tri-fold), finishing (stapling, folding, hole-punching, cutting, trimming), collation (copies, face-up, color separation), rendering (color, dpi, resolution), and consumables (paper stock and ink).

8. The method of claim 4 wherein accepting routing fingerprint information includes accepting information selected from the group including print server name, print server queue, print server network address, port name, and print provider.

9. The method of claim 4 wherein accepting host fingerprint information includes accepting information selected from the group including host name, host machine address (MAC), and host network address.

10. The method of claim 4 wherein accepting target printer fingerprint information includes accepting information selected from the group including printer name, printer model name, printer serial number, and printer network address.

11. The, method of claim 4 wherein accepting metadata fingerprint information includes accepting information selected from the group including access control and anti-copy protection information.

12. The method of claim 1 wherein supplying a fingerprinted print job includes adding the fingerprint image in a process selected from the group including:
adding the fingerprint image to the electronically formatted document prior to rendering the print job;
adding the fingerprint image while rendering the print job; and,
adding the fingerprint image after rendering the print job into a pre-raster image process (RIP) format.

13. The method of claim 1 wherein supplying a fingerprinted print job includes:
generating a print job in a first format selected from the group including a journaled print job, page description language (PDL), machine-dependent raster image data, and machine independent bitmap data; and,
generating the fingerprint image in the first format.

14. The method of claim 1 wherein supplying a fingerprinted print job includes scaling the fingerprint image with respect to the sheet picture frame.

15. The method of claim 1 wherein supplying a fingerprinted print job includes adding the image in a format selected from the group including a barcode, alpha-numeric text, watermark, font set, and steganographic image.

16. The method of claim 1 wherein accepting fingerprint information includes analyzing content information from the electronically formatted document; and,
wherein generating a fingerprint image includes generating a fingerprint image in response to the content information analysis.

17. The method of claim 1 further comprising:
encrypting the fingerprint information; and,
wherein generating a fingerprint image includes generating a fingerprint image from the encrypted fingerprint information.

18. The method of claim 1 further comprising:
subsequent to supplying the fingerprinted print job, rendering the fingerprinted print job using a process selected from the group including copying, scanning, faxing, printing, transferring, and converting the print job format; and
generating a rendered print job with the fingerprint image.

19. The method of claim 1 wherein accepting fingerprint information includes accepting encrypted fingerprint information; and,
wherein generating a fingerprint image includes generating a fingerprint image from the encrypted fingerprint information.

20. The method of claim 19 further comprising:
subsequent to supplying the fingerprinted print job, decrypting the fingerprint image; and,
rendering a print job with the decrypted fingerprint image.

21. The method of claim 1 wherein supplying a fingerprinted print job includes:
adding a fingerprint image as print instructions accompanying a pre-RIP print job; and,
at a printer, rendering the fingerprint image print instructions and pre-RIP print job into a raster image of the fingerprinted print job.

22. The method of claim 1 wherein accepting an electronically formatted document with print instructions at a print job generation system includes accepting the electronically formatted document at a print driver.

23. The method of claim 1 wherein accepting an electronically formatted document with print instructions at a print job generation system includes accepting print instructions in a format selected from the group including print job generation system dependent and print job generation system independent instructions.

24. The method of claim 1 further comprising:
subsequent to supplying a fingerprinted print job, generating a raster image of the fingerprinted print job.

25. A print job generation fingerprinting system, the system comprising:
a print job generation system having an interface to accept an electronically formatted document with print instructions and an interface to accept fingerprint information, the print job generation system generating a fingerprint image from the fingerprint information and supplying a fingerprinted print job at an output.

26. The system of claim 25 further comprising:
a print subsystem having an input to accept the fingerprinted print job and an output to distribute the fingerprinted print job; and,
a printer including:
a raster image processor (RIP) having an input to accept the fingerprinted print job from the print subsystem and an output to supply a raster image of the fingerprinted print job; and,
a print engine having an input to accept the raster image and an output to supply a rendering of the document, with the fingerprint image.

27. The system of claim 25 further comprising:
a host selected from the group including a client computing device, a printer, and a print server; and,
wherein the print job generation system is embedded in the host.

28. The system of claim 25 wherein the print job generation system accepts fingerprint information selected from the group including job ownership/origination, host, target printer, routing, job assembly, job scheduling, metadata, and job content information.

29. The system of claim 28 wherein the print job generation system accepts job ownership/origination fingerprint information selected from the group including user name, biometric data, and a digital signature associated with the electronically formatted document source.

30. The system of claim 28 wherein the print job generation system accepts job scheduling fingerprint information selected from the group including job name, job ID, job submission time and date, and job size.

31. The system of claim 28 wherein the print job generation system accepts job assembly fingerprint information selected from the group including the number of pages/sheets, sheet assembly (duplex, n-up, booklet, tri-fold), finishing (stapling, folding, hole-punching, cutting, trimming), collation (copies, face-up, color separation), rendering (color, dpi, resolution), and consumables (paper stock and ink).

32. The system of claim 28 wherein the print job generation system accepts routing fingerprint information selected from the group including print server name, print server queue, print server network address, port name, and print provider.

33. The system of claim 28 wherein the print job generation system accepts host fingerprint information selected from the group including host name, host machine address (MAC), and host network address.

34. The system of claim 28 wherein the print job generation system accepts target printer fingerprint information selected from the group including printer name, printer model name, printer serial number, and printer network address.

35. The system of claim 28 wherein the print job generation system accepts metadata fingerprint information selected from the group including access control and anti-copy protection information.

36. The method of claim 25 wherein the print job generation system adds the fingerprint image to the print job in a process selected from the group including:
prior to rendering the print job; and,
while rendering the print job.

37. The method of claim 25 further comprising:
a print subsystem having an interface connected to the print job generation system output, a printer interface, a spooler for print job storage; and,
wherein the print job generation system generates and spools journaled data to the print subsystem, and subsequently despools the journaled data and adds the fingerprint image.

38. The system of claim 25 wherein the print job generation system supplies the print job and fingerprint image in a format selected from the group including a journaled print job, page description language (PDL), machine-dependent raster image data, and machine independent bitmap data.

39. The system of claim 25 wherein the print job generation system supplies a fingerprinted print job having the fingerprint image scaled with respect to the sheet picture frame.

40. The system of claim 25 wherein the print job generation system supplies a fingerprinted print job with the fingerprint image in a format selected from the group including a barcode, alpha-numeric text, watermark, font set, and steganographic image.

41. The system of claim 25 wherein the print job generation system analyzes content information from the electronically formatted document, and generates a fingerprint image in response to the content information analysis.

42. The system of claim 25 wherein the print job generation system encrypts the fingerprint information and generates a fingerprint image from the encrypted fingerprint information.

43. The system of claim 25 further comprising:
a rendering system selected from the group including a printer, scanner, fax, http server, document server, email server, and print job converter system, having an input to accept the fingerprinted print job and an output to supply a rendered print job with the fingerprint image.

44. The system of claim 25 wherein the print job generation system accepts encrypted fingerprint information and generates a fingerprint image from the encrypted fingerprint information.

45. The system of claim 44 further comprising:
a rendering system selected from the group including a printer, scanner, fax, http server, document server, email server, and print job converter system, having an input to accept the fingerprinted print job and an output to supply a rendered print job with the decrypted fingerprint image.

46. The system of claim 25 wherein the print job generation system adds a fingerprint image as print instructions accompanying a pre-RIP print job; and,
the system further comprising:
a printer including:
a raster image processor (RIP) having an input to accept the fingerprinted print job, render the fingerprint image print instructions and pre-RIP print job, and supply a raster image of the fingerprinted print job at an output; and,
a print engine having an input to accept the raster image and an output to supply a rendering of the document, with the fingerprint image.

47. The system of claim 25 wherein the print job generation system is a print driver.

48. The system of claim 25 wherein the print job generation system accepts print instructions in a format selected from the group including print job generation system dependent and print job generation system independent instructions.

49. The system of claim 25 further comprising:
a raster image processor (RIP) having an input to accept the fingerprinted print job and an output to supply a raster image of the fingerprinted print job.
